(19) United States
(12) Patent Application Publication
(10) Pub. No.: US 2026/0287043 A1
(43) Pub. Date: Sep. 24, 2026

(54) ROBOCHAIN

(71) Applicant: Hyun Woo Kim, Seoul (KR)

(72) Inventor: Hyun Woo Kim, Seoul (KR)

(21) Appl. No.: 18/869,233

(22) PCT Filed: Apr. 5, 2023
(86) PCT No.: PCT/KR2023/004584

§ 371 Date: Oct. 27, 2025

(30) Foreign Application Priority Data
Aug. 12, 2022 (KR) 10-2022-0101519

(51) Int. Cl. F16G 13/16; F16L 3/23

(52) U.S. Cl. CPC F16G 13/16; F16L 3/23

(57) ABSTRACT

The present disclosure is to provide a robochain which is capable of improving assembling performance by connecting plates without using an additional connection member, and preventing noise by minimizing contacts between plates. In the robochain according to the present disclosure, a plate and a corresponding plate are connected to be rotatable while partially overlapping each other in a circular overlapping region, are rotated while a rotating protrusion formed on the plate moves along a rotating groove formed in the corresponding plate, and are fastened with each other when a connecting pin of the plate is fitted into a connecting pin coupling groove of the corresponding plate.

### TECHNICAL FIELD

The present disclosure relates to a robochain, and more specifically, to a robochain that can be simply assembled without a separate connecting member, does not generate noise, and reduces abrasion of cabling, and the like accommodated therein.

### BACKGROUND ART

In general, a robochain is a device used in industrial sites that handle various types of machinery, and has a chain structure that allows bending motion between a straight state and a curved state, and through this bending motion, the robochain reciprocates pneumatic hoses, cables, etc. (hereinafter referred to as “cabling”) accommodated in its internal space.

In this regard, as a prior art related to robochain, Korean Patent No. KR10-1196888B1 (Patent Document 1) assigned to the applicant of the present application has been disclosed.

Patent document 1 relates to a robochain and a connecting member used therein, and includes a plurality of link units (or plates), a connecting member configured to connect the link units, a concave portion formed on an inside of the link unit so that the connecting member may be detachably connected to each of the link units, and a neck portion formed on the connecting member so that the connecting member does not easily come off when coupled to the concave portion.

However, in the conventional robochain, the connecting member is inserted into the concave portion to connect the link unit, but not only is it inconvenient to couple the connecting member, but the link unit should be connected through the connecting member, so the assembly process is complicated, and there is a problem that the neck portion of the connecting member protrudes into the inside of the chain link to cause cabling to be abraded.

### DISCLOSURE OF THE INVENTION

### Technical Problem

The present disclosure is devised in consideration of the above-described problem, an object of the present disclosure is to provide a robochain in which plates are connected to each other without separate connecting member to improve assembleability, a contact between plates is minimized to prevent noise from being generated, and an inner side of the plate that comes into contact with cabling is formed to have a flat shape to reduce abrasion of cabling accommodated therein.

### Technical Solution

In order to achieve the above object, a robochain according to present disclosure includes chain links connected continuously to each other in the length direction of a chain, each of the chain links being comprised of a pair of plates facing each other with a certain gap therebetween and a link connecting an upper portion or a lower portion of these plates, the robochain is characterized in that a corresponding plate connected to one plate is formed to have the same shape and is connected to the plate while partially overlapping with the plate in a circular overlapping region having a concave step, in the plate, a hollow cylindrical-shaped connecting pin is formed protrudely on a central portion of the overlapping region and three rotating protrusions are formed protrudely on an edge thereof at regular intervals, in the corresponding plate, an inner ring and an outer ring having a connecting pin-coupling recess are formed protrudely thereon, three stoppers are formed between the inner ring and the outer ring at regular intervals to provide three rotating grooves, each of which being formed between the stoppers, respectively, the plate and the corresponding plate are rotated while the rotating protrusions are moved along the rotating grooves, respectively, and the connecting pin is fitted into the connecting pin-coupling recess to allow the plate and the corresponding plate to be coupled.

A rail groove may be formed on an outer periphery of the connecting pin, and a rail protrusion that is coupled with the rail groove may be formed on an inner periphery of the connecting pin-coupling recess.

The rotating groove may be configured such that the length of the outer ring side is longer than the length of the inner ring side not to allow a side surface of the rotating protrusion and a side surface of the stopper to come into contact with other.

A lower surface of the plate, which comes into contact with a floor surface on which the robochain is placed, may have a rounded shape.

A rotating space, which extends from the overlapping region to an outside the overlapping region may be further provided in the plate and the corresponding plate.

A width of the overlapping region on which the plate and the corresponding plate are coupled may be larger than a width which is the sum of a width of the plate and a width of the corresponding plate at an edge of the overlapping region,

The inner side surface of the plate, which is exposed to an inner side of the chain link, may be formed as a flat surface.

The connecting pin may have a cylindrical shape.

The rotating protrusions, the stoppers, and the rotating grooves may be provided in one pair at the same distance, respectively.

### Advantageous Effects

In the robochain according to the present disclosure, the plate and the corresponding plate may be configured to be coupled to each other only using an undercut and a shape corresponding thereto, so that they may be easily coupled without a separate coupling member.

In addition, in the robochain according to the present disclosure, the plate and the corresponding plate are coupled to each other only with the connecting pin and the connecting pin-coupling recess, so that they may be easily disassembled or assembled.

Also, in the robochain according to the present disclosure, since the contact between the plate and the corresponding plate is made to a minimum, noise or dust generation may be significantly reduced.

In addition, in the robochain according to the present disclosure, the inner surface of the plate which is in contact with the cabling is flat, it has the effect of reducing wear or damage to the accommodated cabling.

### BRIEF DESCRIPTION OF THE DRAWINGS

FIG. 1 is a perspective view showing an assembled state of a robochain according to one embodiment of the present disclosure.

FIG. 2 is a perspective view illustrating one chain link in an assembled state in a robochain according to one embodiment of the present disclosure.

FIG. 3 is a perspective view showing one chain link of FIG. 2 in an exploded state.

FIG. 4 is an exploded perspective view showing a connecting state between a plate and a corresponding plate according to one embodiment of the present disclosure.

FIG. 5 is an exploded perspective view showing a connecting state between a plate and a corresponding plate according to one embodiment of the present disclosure and viewed from a different angle.

FIG. 6 is a partial cross-sectional view showing a state in which a connecting pin according to one embodiment of the present disclosure is connected to a connecting pin-coupling recess.

FIGS. 7 to 9 are exemplary views of an essential part showing a coupling state between a plate and a corresponding plate according to one embodiment of the present disclosure.

FIG. 10 is a side view and a top view showing a coupling state between a plate and a corresponding plate according to one embodiment of the present disclosure.

### BEST MODE FOR CARRYING OUT THE INVENTION

Hereinafter, a robochain according to the present disclosure will be described in detail with reference to the drawings.

Since the present disclosure may have various modifications and may have various embodiments, specific embodiments will be illustrated in the drawings and described in detail in the detailed description. However, the detail description is not intended to limit the present disclosure to a specific embodiment, it should be understood that the detail description includes all modifications, equivalents and substitutes included in the spirit and technical scope of the present disclosure.

When it is mentioned said that one component is “connected” or “joined” to another component, it should be understood that one component may be directly connected or joined to another component, but other component may also be interposed between these components. On the other hand, when it is mentioned that one component is “directly connected” or “directly joined” to another component, it should be understood that no other component is disposed between these components.

The terms used in the description and the appended claims is employed for explaining a specific embodiment, and are not intended to limit the present disclosure. The singular forms include the plural forms, unless the context clearly indicates otherwise.

It should be understood that, in the specification, the terms “include(s)” or “have(has)”, or the like is employed for specifying the presence of features, numbers, steps, operations, components, parts or combination thereof stated in the specification, but does not preclude in advance the presence or addition of one or more other features, numbers, steps, operations, components, parts, or combination thereof.

In addition, components of an embodiment described with reference to each drawing are not limitedly applied to only that embodiment, and may be implemented to be included in another embodiment within the scope in which the technical spirit of the present disclosure is maintained. Furthermore, even though a separate description is omitted, it is obvious that the present disclosure may be implemented again as one embodiment into which the plurality of embodiments are integrated embodiment.

In addition, when the present disclosure is described with reference to the accompanying drawings, regardless of the reference numerals, the same or related reference numeral is given to the same component, and a repeated description thereon will be omitted. In describing the present disclosure, if it is determined that a detailed description for a related known technology may unnecessarily obscure the gist of the present disclosure, a detailed description thereof will be omitted.

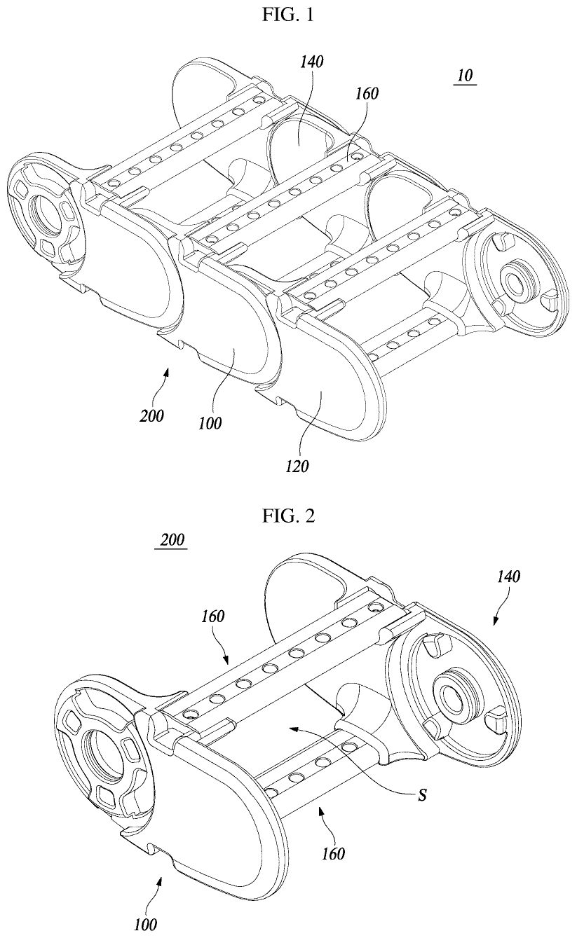

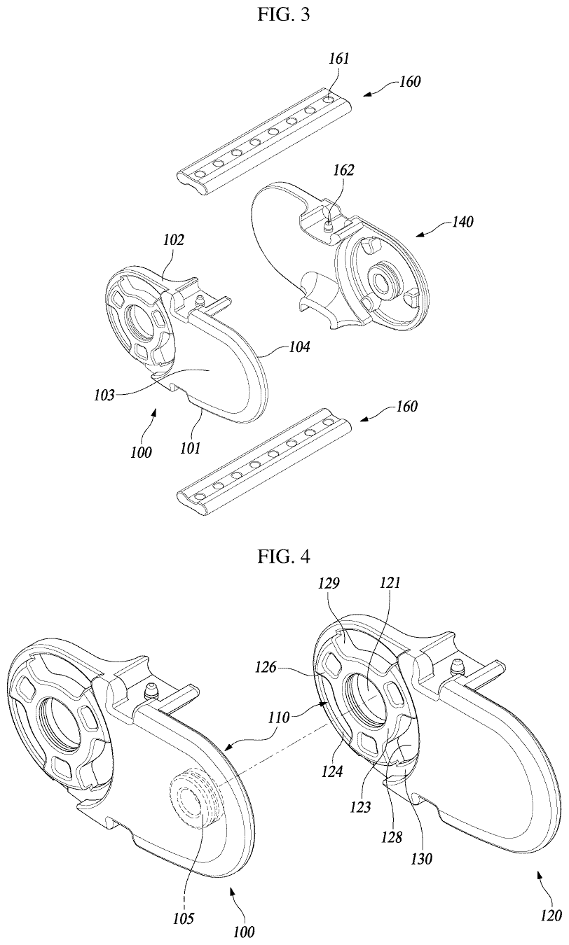

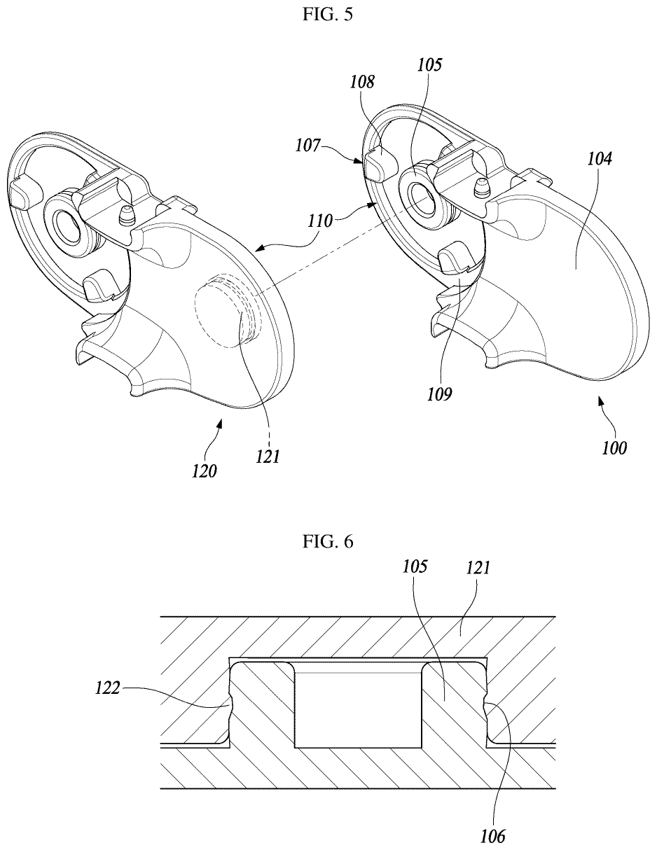

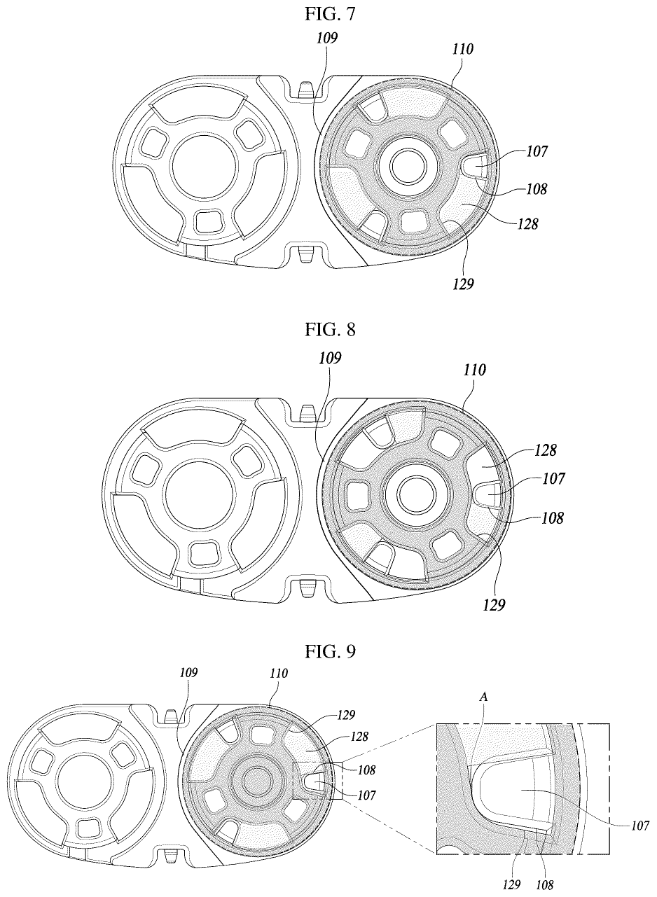

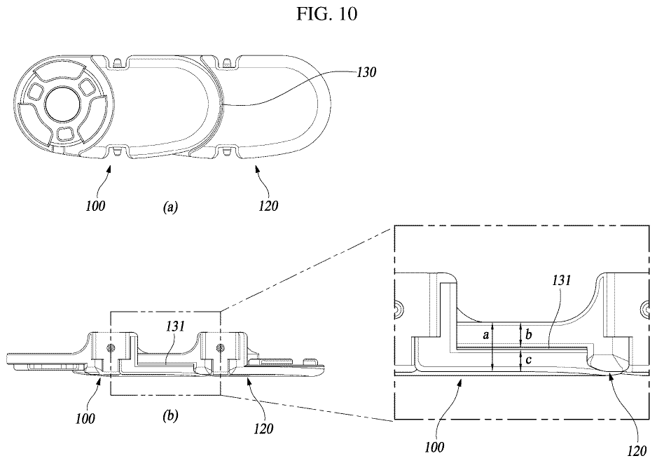

FIG. 1 is a perspective view showing an assembled state of a robochain according to one embodiment of the present disclosure, FIG. 2 is a perspective view illustrating one chain link in an assembled state in a robochain according to one embodiment of the present disclosure, FIG. 3 is a perspective view showing one chain link of FIG. 2 in an exploded state, FIG. 4 is an exploded perspective view showing a connecting state between a plate and a corresponding plate according to one embodiment of the present disclosure, and FIG. 5 is an exploded perspective view showing a connecting state between a plate and a corresponding plate according to one embodiment of the present disclosure and viewed from a different angle. In addition, FIG. 6 is a partial cross-sectional view showing a state in which a connecting pin according to one embodiment of the present disclosure is connected to a connecting pin-coupling recess, FIGS. 7 to 9 are exemplary views of an essential part showing a coupling state between a plate and a corresponding plate according to one embodiment of the present disclosure, and FIG. 10 is a side view and a top view showing a coupling state between a plate and a corresponding plate according to one embodiment of the present disclosure.

As shown in the drawings, a robochain according to one embodiment of the present disclosure is a robochain in which chain links 200 are connected continuously to each other in the length direction of a chain, each of the chain links being comprised of a pair of plates 100, 140 facing each other with a certain gap therebetween and a link 160 connecting an upper portion or a lower portion of these plates 100, 140, this robochain is characterized in that a corresponding plate 120 connected to one plate 110 is formed to have the same shape and is connected to the plate while partially overlapping with the plate 110 in a circular overlapping region 110 having a concave step, in the plate 100, a hollow cylindrical-shaped connecting pin 105 is formed protrudely on a central portion of the overlapping region 110 and three rotating protrusions 107 are formed protrudely on an edge thereof at regular intervals, in the corresponding plate 120, an inner ring 123 and an outer ring 124 having a connecting pin-coupling recess 121 are formed protrudely thereon, three stoppers 126 are formed between the inner ring and the outer ring at regular intervals to provide three rotating grooves 128, each of which being formed between the stoppers, respectively, the plate and the corresponding plate are rotated while the rotating protrusions 107 are moved along the rotating grooves 128, respectively, and the connecting pin 105 is fitted into the connecting pin-coupling recess 121 to allow the plate and the corresponding plate to be coupled.

The robochain according to the present disclosure is formed by continuously connecting the chain links 200 to each other in the length direction of a chain, each of the chain links being comprised of the pair of plates 100, 140 facing each other with a certain gap therebetween and the link 160 connecting an upper portion or a lower portion of these plates 100, 140. Here, the opposing plate 140 is formed substantially symmetrically with the plate 100, and the adjacent corresponding plate 120 connected to the plate 100 is formed to have the same shape as the plate 100, so the plate 100 and the corresponding plate 120 are connected to each other to enable these plates to be rotated with respect to each other.

In addition, the upper portions or lower portions of the above pair of plates 100, 140 are connected by the link 160. On the upper and lower portions of the plates, link-coupling parts 162 to which the link 160 is coupled are formed, the link 160 has link-coupling holes 161 that may be coupled to the link-coupling part 162. The above coupling structure of the plate 100 and the link 160 may be formed in various other forms as long as it may couple the plate and the link.

As depicted in FIG. 2, the chain link 200, including the pair of plates 100, 140 facing each other and the link 160, has an approximately square-shaped space S formed therein, cabling is accommodated in this space S. The robochain 10 is formed by continuously connecting these chain links 200 so that they may be rotated in the length direction of the chain.

As described above, the opposing plate 140 has a shape and structure that are substantially symmetrical with those of the plate 100, and the corresponding plate 120 adjacent to a right side of the plate 100 and connected to the plate 100 has the same shape and structure as those of the plate 100. In the present disclosure, the left plate will be referred to as the plate 100, and the right plate will be referred to as the corresponding plate 120.

As depicted in FIG. 3, the plate 100 has a constant length in the longitudinal direction of the chain, has an upper surface 102, a lower surface 101, an inner side surface 104, and an outer side surface 103, and both end portion thereof are formed into an approximately semicircular shape. In the present disclosure, the lower surface 101 of the plate 100, which comes into contact with a floor surface on which the robochain 10 is placed, may be formed into a rounded shape. Since the plate with the rounded lower surface comes smoothly into contact with the floor surface, noise caused by contact between the plate and the floor surface when the robochain runs may be reduced.

As shown in FIGS. 4 and 5, a concave step is formed on the inner side surface 104 of a right end portion of the plate 100, and the concave step has an approximately circular shape. To correspond to this configuration, a concave step is also formed on the outer side surface 103 of a left end portion of the corresponding plate 120, and this concave step, like the concave step of the plate 100, has an approximately circular shape. The plate 100 and the adjacent corresponding plate 120 are connected while partially overlapping on this circular overlapping region 110 (see FIG. 7).

The plate 100 and the corresponding plate 120 are assembled so as to enable two plates to be rotated at a certain angle. As shown in the drawing, on the plate 100, the hollow cylindrical connecting pin 105 is formed protrudly on a center of the overlapping region 110, and the three rotating protrusions 107 are formed protrudly on the edge at regular intervals. Although the connecting pin 105 is formed in a hollow cylindrical shape in this embodiment, the connecting pin 105 may also be formed in a cylindrical shape. However, a hollow cylindrical shaped connecting pin 105 is more preferable in terms of weight reduction of the component or reduction of manufacturing cost.

In the corresponding plate 120, the connecting pin-coupling recess 121, the inner ring 123 and the outer ring 124 are formed on the overlapping 110. Here, the inner ring 123 is formed to be protruded more than the outer ring 124. In addition, between the inner ring and the outer ring, the three stoppers 26 are formed at regular intervals, and extended to the same height as the inner ring 123. Therefore, the three rotating grooves 128 are formed in the space defined by the inner ring 123, the outer ring 124, and the stoppers placed on both sides. The rotating groove 128 is a space to enable the plate 100 to be rotated, and a maximum rotation angle of the plate 100 may be adjusted by adjusting an arc length of the rotating groove 128.

The rotating groove 128 is configured such that the length of the outer ring side is longer than the length of the inner ring side. As shown in FIG. 9, this is to prevent a side surface 108 of the rotating protrusion 107 from coming into contact with a side surface of the rotating groove 128 when the plate 100 is rotated at the maximum rotation angle, thereby preventing a generation of noise caused by a contact between of the rotating protrusion 107 and the side surface rotating groove 128 when the robochain runs. This function be described later.

The connecting pin 105 of the plate 100 has an outer diameter that is approximately the same as an inner diameter of the connecting-pin coupling recess 121 of the corresponding plate 120, so it is configured such that it may be fitted into the connecting pin-coupling recess 121. Therefore, the plate 100 and the corresponding plate 120 are coupled in a rotatably state by fitting the connecting pin 105 of the plate 100 into the connecting pin-coupling recess 121 of the corresponding plate 120 and by inserting the rotating protrusion 107 of the plate 100 into the rotating groove 128 of the corresponding plate 120.

The plate 100 and the corresponding plate 120 overlap with each other on the overlapping region 110 to be rotatably coupled, and the inner side surfaces 104 of the plate 100 and the corresponding plate 120, which are exposed to an inner side of the chain link 160, are formed as a flat surface. Therefore, as shown in FIG. 1, in the accommodating space S in which cabling is accommodated, the inner side surface of the plate is formed as a flat surface with no protruding portion, so that it is possible to protect cabling from being abraded or damaged.

In addition, as shown in FIG. 6, a rail groove 106 may be formed on an outer periphery of the connecting pin 105, and a rail protrusion 122 that is coupled with the rail groove 106 may be formed on an inner periphery of the connecting pin-coupling recess 121. When the connecting pin 105 and the connecting pin-coupling recess 121 are coupled using the rail groove and the rail protrusion, the plate 100 and the corresponding plate 120 may be more firmly coupled and may rotate smoothly with each other. Conversely, it is also possible to form a rail protrusion on the connecting pin and a rail groove on the connecting pin-coupling recess.

In addition, since a part on which the connecting pin 105 and the connecting pin-coupling recess 121 are coupled is completely sealed by the outer sides of the plates, even if dust is generated due to friction when the connecting pin 105 is rotated in the connecting pin-coupling recess 121, it is possible to prevent the generated dust from being dispersed out of the plates.

In addition, in one embodiment of the present disclosure, the three rotating protrusions 107, the three stoppers 126, and three the rotating grooves 128 are shown as being formed at regular intervals, but the rotating protrusions 107, the stoppers 126, and the rotating grooves 128 may also be provided in one pair at the same distance, respectively. However, compared to the case where the rotation protrusions 107, the stoppers 126 and the rotating groove 128 are formed as a pair, the three rotating protrusions 107, the three stoppers 126, and three the rotating grooves 128 may strongly support at three points, so a support strength is enhanced, and this configuration also has the advantage of dispersing stress.

FIGS. 7 to 9 depict the coupling relationship between the plate 100 and the corresponding plate 120 as an example (i.e., in order to show the coupling relationship with the plate 100 and the corresponding plate in more detail, only the overlapping region of the corresponding plate 120 is illustrated in the drawings). Here, FIG. 7 illustrates a case where the robochain is in a straight state, and FIGS. 8 and 9 illustrate a case where the robochain is in a bent state.

As shown in FIG. 7, as the connecting pin 105 of the plate 100 is fitted into the connecting pin-coupling recess 121 of the corresponding plate 120, the rotation protrusion 107 of the plate 100 is inserted into the rotating groove 128 of the corresponding plate 120, and the two plates are coupled to enable both to be rotated at a certain angle.

In this state, when a left end portion of the plate 100 or a right end of the corresponding plate 120 is rotated upward, the rotating protrusion 107 is gradually moved along the rotating groove 128, causing the plate 100 or the corresponding plate 120 to be rotated. FIG. 8 illustrates an intermediate stage in which the plate 100 or the corresponding plate 120 is rotated, and FIG. 9 illustrates a state in which the plate 100 or the corresponding plate 120 is rotated to the maximum rotation angle.

As shown in an enlarged portion of FIG. 9, when the plate 100 is rotated to the maximum rotation angle, a top portion A of the rotating protrusion 107 is pressed against the inner ring side of the rotating groove 128 and is braked, so that the rotation protrusion 107 is no longer moved. Therefore, the side surface 108 of the rotating protrusion and the side surface of the rotating groove 128 (i.e., which is a side surface of the stopper 126) do not come into contact with each other when the plate 100 or the corresponding plate 120 is rotated. Due to the above, even when the plate 100 or the corresponding plate 120 is rotated to the maximum rotation angle, the contact is made only at the minimum contact point, thereby significantly reducing noise caused by contact during rotation.

In addition, a rotating space 109, 130, which extends from the overlapping region 110 to an outside the overlapping region where the plate 100 and the corresponding plate 120 overlap each other, is provided. When the plate 100 and the corresponding plate 120 is rotated, their side surfaces do not come into contact with each other due to the rotating space 109, 130, which is a spare space, and the two plates may be rotated smoothly, and therefore, when the plate 100 or the corresponding plate 120 is rotated, noise due to contact between the side surfaces is not generated, and dust is prevented from being generated due to friction.

FIG. 10 illustrates the coupling relationship between the plate 100 and the corresponding plate 120 in a side view and a top view. A side view of (a) in FIG. 10 exemplarily illustrates that a rotating space 130 is formed in the corresponding plate 120, so the side surfaces of the plate 100 and the corresponding plate 120 may be rotated smoothly without coming into contact with other.

In addition, as shown in (b) of FIG. 10, a width a of the overlapping region 110 on which the plate 100 and the corresponding plate 120 are coupled is formed to be larger than a width b+c, which is the sum of a width c of the plate and a width b of the corresponding plate at an edge of the overlapping region, so that a gap 131 exists between the plate 100 and the corresponding plate 120 at the edge of the overlapping region. That is, except for the parts where the connecting pin 105 and the rotating protrusion 107 of the plate 100 are coupled to the connecting pin-coupling recess 121 and the rotating groove 128 of the corresponding plate 120 in the overlapping region 110, the plate 100 and the corresponding plate 120 do not any contact portions coming into contact with each other. Accordingly, when the plate 100 or the corresponding plate 120 is rotated, the inner side surface 104 of the plate 100 and the outer side surface 103 of the corresponding plate 120 do not come into contact with each other, so that noise caused by contact is not generated, and also, generation of dust due to friction is further prevented.

As examined above, in the robochain 10 according to the present disclosure, the plate and the corresponding plate may be configured to be coupled to each other only using an undercut and a shape corresponding thereto, so that they may be easily coupled without a separate coupling member, the plate and the corresponding plate are coupled to each other only with the connecting pin and the connecting pin-coupling recess, so that they may be easily disassembled or assembled, and since the contact between the plate and the corresponding plate is made to a minimum, noise or dust generation may be significantly reduced. In addition, the inner surface of the plate which is in contact with the cabling is flat, it has the effect of reducing abrasion or damage to the accommodated cabling.

In the above, the present disclosure has been illustrated and described in connection with a preferred embodiment for illustrating the principle of the present disclosure, but the present disclosure is not limited to the configuration and operation as shown and described as such. Rather, it will be well understood by those skilled in the art that many changes and modifications can be made to the present disclosure without departing from the spirit and scope of the appended claims.

1. A robochain comprising chain links connected continuously to each other in the length direction of a chain, each of the chain links being comprised of a pair of plates facing each other with a certain gap therebetween and a link connecting an upper portion or a lower portion of these plates, characterized in that:
a corresponding plate connected to one plate is formed to have the same shape and is connected to the plate while partially overlapping with the plate in a circular overlapping region having a concave step,
in the plate, a hollow cylindrical-shaped connecting pin is formed protrudely on a central portion of the overlapping region and three rotating protrusions are formed protrudely on an edge thereof at regular intervals,
in the corresponding plate, an inner ring and an outer ring having a connecting pin-coupling recess are formed protrudely thereon, three stoppers are formed between the inner ring and the outer ring at regular intervals to provide three rotating grooves, each of which being formed between the stoppers, respectively,
the plate and the corresponding plate are rotated while the rotating protrusions are moved along the rotating grooves, respectively, and the connecting pin is fitted into the connecting pin-coupling recess to allow the plate and the corresponding plate to be coupled.

2. The robochain of claim 1, wherein a rail groove is formed on an outer periphery of the connecting pin, and a rail protrusion that is coupled with the rail groove is formed on an inner periphery of the connecting pin-coupling recess.

3. The robochain of claim 1, wherein the rotating groove is configured such that the length of the outer ring side is longer than the length of the inner ring side not to allow a side surface of the rotating protrusion and a side surface of the stopper to come into contact with other.

4. The robochain of claim 1, wherein a lower surface of the plate, which comes into contact with a floor surface on which the robochain is placed, has a rounded shape.

5. The robochain of claim 1, wherein a rotating space, which extends from the overlapping region to an outside the overlapping region is further provided in the plate and the corresponding plate.

6. The robochain of claim 1, wherein a width of the overlapping region on which the plate and the corresponding plate are coupled is larger than a width which is the sum of a width of the plate and a width of the corresponding plate at an edge of the overlapping region.

7. The robochain of claim 1, wherein the inner side surface of the plate, which is exposed to an inner side of the chain link, is formed as a flat surface.

8. The robochain of claim 1, wherein the connecting pin has a cylindrical shape.

9. The robochain of claim 1, wherein the rotating protrusions, the stoppers, and the rotating grooves are provided in one pair at the same distance, respectively.
